(19) United States
(12) Patent Application Publication
(10) Pub. No.: US 2004/0183334 A1
(43) Pub. Date: Sep. 23, 2004

(54) Dump body with shock absorbing floor

(76) Inventor: Marcel Bibeau, St-Felix-de-Valois (CA)

Correspondence Address: ROBIC, 55 St Jacques, Montreal, H2Y 3X2, CA

(21) Appl. No.: 10/804,037

(22) Filed: Mar. 19, 2004

(30) Foreign Application Priority Data
Mar. 21, 2003 (CA) 2,423,014

(51) Int. Cl. B62D 33/02

(52) U.S. Cl. 296/183.2

(57) ABSTRACT

Disclosed is a dump body for mounting on the frame of a truck. This dump body has a floor under which two parallel longsills extend longitudinally for reinforcing the same. Advantageously, the two longsills are mounted in adjacent position with respect to each other in the middle of the floor instead of being spaced apart under the same. The longsills that are so attached to the floor, altogether have a W-shape and act as a spring which absorbs and retransmits shocks due to impacts received during loading of the dump body.

### FIELD OF THE INVENTION

The present invention relates to a dump body for use on a vehicle. More specifically, the invention relates to a dump body without cross-members, which is devised for mounting on the frame of a truck.

### BACKGROUND OF THE INVENTION

Dump bodies for mounting on trucks are well known. Most of these dump bodies are devised so as to have a high resistance especially during loading. However, they do not have much flexibility to absorb shocks during loading. U.S. Pat. No. 4,273,381 in the name of the Applicant discloses a dump body comprising a floor mounted in a rigid manner on two parallel longsills that are spaced from each other and do not offer any flexibility to impact during loading of the dump body. Over a given period of time, these shocks generate a significant deterioration of the floor and the steel plates forming them. These repeated shocks may sometimes cause also collapsing of the longsills, thereby reducing the rigidity of the under structure of the dump body. They may even cause a disassembly of some parts of it.

Moreover, the sides of the conventional dump bodies often lose their rigidity over the time due to a lack of support at their upper edges, as well as to the way they are assembled with the floor that does not resist to the multiple loadings to which they are subjected.

Moreover, the central surface of the floor, which is not heated between the longsills, may create an instable zone of conditioning that may cause unwanted deformations.

### OBJECTS OF THE INVENTION

A first object of the present invention is to provide a dump body having a higher resistance to the shocks occurring during loading, thanks to a better conception of its floor and longsills.

A second object of the invention is to provide a dump body having side walls that are devised in such a manner as to better resist to the shocks and load stress over a long period of time.

A third object of the invention is to provide a dump body wherein more surface of the floor may be exposed to heating due to the wider enclosed surface within the longsills located in adjacent relationship.

### SUMMARY OF THE INVENTION

In accordance with the invention, the above mentioned first object is achieved by means of a dump body with a shock absorbing floor, which distinguishes over the existing ones by the geometric conception of its floor and longsills, which gives better flexibility to the places that are subjected to high constraint due to the loads.

More specifically, the first object of the invention is to provide a dump body without cross-members, for mounting on a truck. This dump body comprises two adjacent longitudinal longsills on which is mounted a floor provided with two side walls. A front wall and a rear door may complete the assembly to form a rigid body shell that is geometrically devised in such a manner as to keep some flexibility at the places where such is required. This dump body is intended to be mounted onto a conventional truck and has, at equal weight of load, a central portion that has a better resistance to loading.

Thus, the invention as claimed hereinafter is directed to a dump body for mounting on the frame of a truck. This dump body basically comprises:

a floor;

two side walls;

and

two parallel longsills extending longitudinally under the floor, the longsills being rigidly attached to the floor for reinforcing the same.

The improvement essentially lies in that the two longsills are mounted in adjacent position with respect to each other in the middle of the floor instead of being spaced apart under the same, the longsills attached to the floor having altogether a W shape and acting as a spring which absorbs and spreads out shocks due to impacts received during loading of the dump body.

On the other hand, the second object of the invention is achieved by a dump body of the type comprising:

a floor; and

two side walls.

This dump body is improved in that the side walls have upper edges that are formed in order to reinforce them, to contribute to the spring effect and to recenter a stress load.

Details of the new geometrical conception of the floor and longsills of the dump body according to the invention will be better understood upon reading of the following non-restrictive description of several preferred embodiments thereof, made with reference to the accompanying drawings.

### DESCRIPTION OF THE DRAWINGS

FIG. 1 is identified as “prior art” is a front elevational view of the dump body disclosed in U.S. Pat. No. 4,273,381, which is illustrative of the structure of the existing dump bodies;

FIG. 2 is an isometric view of a section of a dump body according to a first preferred embodiment of the invention, said dump body having a conventional shape when seen in cross-section;

FIG. 3 is an isometric view showing a section of a dump body according to a second preferred embodiment of the invention, said dump body having a rounded shape when seen in cross-section;

FIG. 4 is a front elevational view showing the assembly of two longsills having together a W-shape with square angles, said longsills being located under the floor of a dump body according to the invention; and

FIG. 5 is a front elevational view of two longsills having all together a W-shape with rounded angles, said longsills being located under the floor of the dump body according to the invention.

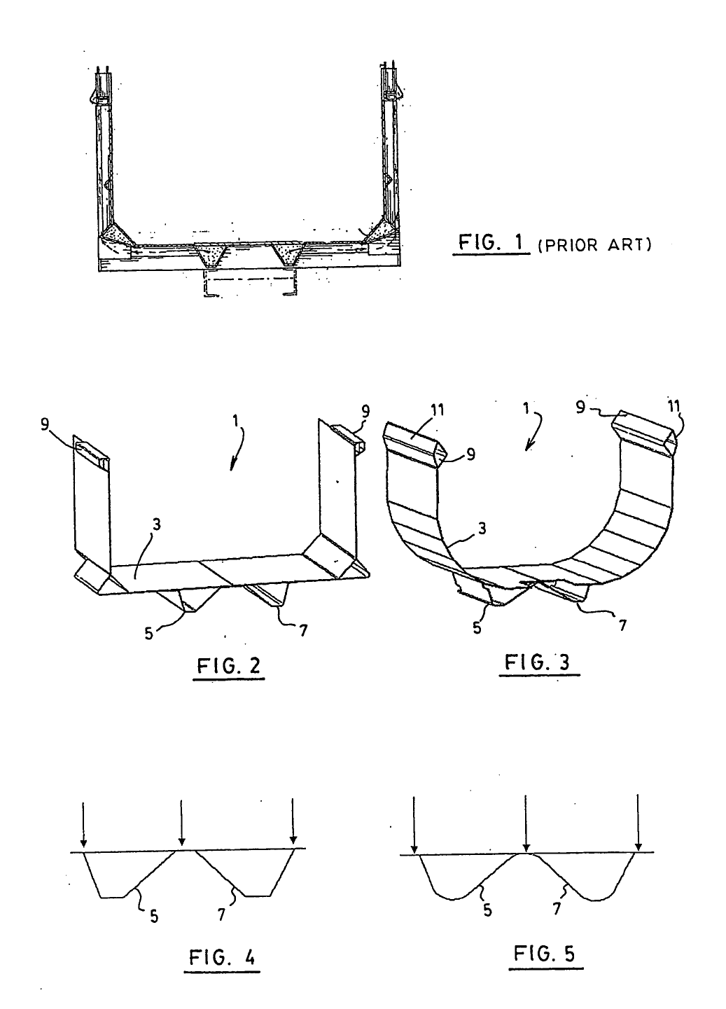

### DETAILED DESCRIPTION OF THE INVENTION

As disclosed hereinabove, the invention is directed to an improved dump body 1 without cross-members, wherein the floor 3 and the longsills 5 and 7 are of a new design and are positioned in a new way. More specifically, the longsills 5, 7 are mounted in adjacent relationship with respect to each other in the middle of the floor instead of being spaced apart under the same. As a result, it is now necessary to make only two (2) or three (3) weldings instead of four (4) in order to fix the longsills and improve the strength of the central portion of the floor by an increased support.

Thanks to their construction and respective positions, the floor 3 and the longsills 5, 7 altogether act as a spring which absorbs and transfers the deformation energy generated by shocks during loading of the dump body. The very specific shape and the physical properties of the material used for the manufacture of the floor and longsills permit to achieve the requested effect and thus improve the resistance of the whole assembly by giving it more flexibility. A spring effect is achieved by the specific shape of the longsills which, due to the fact that they are adjacent to each other, form a double-shaped support under the floor (see FIGS. 2 to 5). During impacts, there is a deformation of the whole assembly formed by the floor and the longsills and subsequent repositioning of the whole assembly in its original position. Inasmuch as the longsills are adjacent instead of being spaced apart, a higher support is obtained for the central portion of the floor.

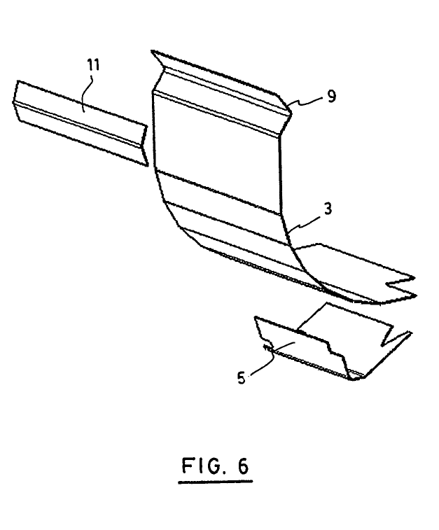

From a practical standpoint, the longsills 5, 7 may have square angles (see FIG. 4) or rounded angles (see FIG. 5) at their supporting parts. This new floor support can be used on a conventional dump body. For the above mentioned reasons, all the other details of structure of the dump body needs not be further described in greater detail.

As shown in FIGS. 2 and 3, the assembly of the dump body comprising the floor 3 and longsills 5, 7 having altogether a double W-shaped may be achieved either by welding four pieces to the middle of the dump body (two side portions of the floor with two adjacent longsills each of a V-shape), or by welding three pieces in the central portion of a floor (two side portions of the floor with a single piece having a double W-shape, which acts as two longsills).

Each side portion of the floor can be of a conventional shape (see FIG. 2). However, advantageously, each side portion may have a rounded shape when seen in cross-section which permits to more uniformly recenter the load onto the floor during impacts (see FIG. 3).

Advantageously also, the side walls of the dump body may have upper edges 9 that are formed in such a manner as to add strength to the whole assembly while also contributing to the spring effect that permits to absorb shocks and subsequently return to the original position and shape. These formed upper edges prevent the mandatory use of an add-on welded stiffener. Preferably, the upper edges of the side walls have a V shape whose angular portions face each other. If needs be, a V-shaped pieces numbered 11 in FIG. 3 may be welded externally onto the formed upper edge of each side wall to reinforce them.

Like in the dump body disclosed in the above mentioned U.S. patent, the gas generated by the truck may be fed into the longsills of the dump body in order to heat the bottom surface of the floor and its side walls. In this connection, it is worth noting that the new geometry given to the longsills provides a wider enclosed surface under the floor, thereby allowing a more uniform heating of the floor while ensuring better result during unloading of a dump body because the load has less tendency to stick onto the surface of it. Accordingly, there is significant less place of the floor that is non-heated, thereby reducing the thermal differences between the various sections of the floor.

1. In a dump body for mounting on the frame of a truck, said dump body comprising:
a floor;
two side walls; and
two parallel longsills extending longitudinally under the floor, said longsills being rigidly attached to the floor for reinforcing the same,
the improvement wherein:
the two longsills are mounted in adjacent position with respect to each other in the middle of the floor instead of being spaced apart under the same, the longsills attached to the floor having altogether a W-shape and acting as a spring which absorbs and spreads out shocks due to impacts received during loading of the dump body.

2. The improved dump body according to claim 1, wherein the longsills having altogether a W-shape have square angles.

3. The improved dump body according to claim 1, wherein the longsills having altogether a W-shape have rounded angles.

4. The improved dump body according to claim 1, wherein the longsills are made of two distinct pieces welded in adjacent position under the floor.

5. The improved dump body according to claim 1, wherein the longsills are made of one single piece having a W-shape, which is welded under the floor.

6. The improved dump body according to claim 1, wherein the floor has a rounded shape when seen in cross-section to uniformly spread a stress load.

7. The improved dump body according to claim 1, wherein the side walls have upper edges that are formed in order to reinforce them, to contribute to the spring effect and to recenter a stress load.

8. The improved dump body according to claim 7, wherein the upper edges of the side walls have a V shape whose angular portions face each other.

9. The improved dump body according to claim 8, further comprising V-shaped pieces welded externally onto the formed upper edges of the side walls to reinforce them.

10. The improved dump body according to claim 1, wherein the floor is made of two pieces, each including half of the floor and one of the side walls, said two pieces being joined to each other by welding.

11. The improved dump body according to claim 1, further comprising a front wall and a rear door completing the dump body.

12. The improved dump body according to claim 4, wherein:
the floor has a rounded shape when seen cross-section to spread a stress load;
the side walls have upper edges that are formed in order to reinforce them, to contribute to the spring effect and to redirect the stress load;
V-shaped pieces are welded externally onto the formed upper edges of the side walls to reinforce them; and
a front wall and a rear door are completing the dump body.

13. The improved dump body according to claim 5, wherein:
the floor has a rounded shape when seen cross-section to spread a stress load;
the side walls have upper edges that are formed in order to reinforce them, to contribute to the spring effect and to redirect the stress load;
V-shaped pieces welded externally onto the formed upper edges of the side walls to reinforce them; and
a front wall and a rear door completing the dump body.

14. In a dump body of the type comprising:
a floor; and
two side walls,
the improvement wherein the side walls have upper edges that are formed in order to reinforce them, to contribute to the spring effect and to recenter a stress load.

15. The improved dump body of claim 14, wherein the upper edges of the side walls have a V shape whose angular portions face each other.

16. The improved dump body of claim 15, further comprising V-shaped pieces welded externally onto the formed upper edges of the side walls to reinforce them.
